(19) United States
(12) Patent Application Publication
(10) Pub. No.: US 2026/0095830 A1
(43) Pub. Date: Apr. 2, 2026

(54) TECHNOLOGIES FOR USER EQUIPMENT GROUP MOBILITY CAUSED BY INTER-DONOR FULL MIGRATION

(71) Applicant: Apple Inc., Cupertino, CA (US)

(72) Inventors: Peng Cheng, Beijing (CN); Yuqin Chen, Beijing (CN); Haijing Hu, Los Gatos, CA (US)

(73) Assignee: Apple Inc., Cupertino, CA (US)

(21) Appl. No.: 19/112,224

(22) PCT Filed: Sep. 16, 2022
(86) PCT No.: PCT/CN2022/119343

§ 371 Date: Mar. 14, 2025

(51) Int. Cl. H04W 36/08; H04W 36/00; H04W 76/27; H04W 76/38

(52) U.S. Cl. CPC H04W 36/083; H04W 36/0079; H04W 76/27; H04W 76/38

(57) ABSTRACT

The present application relates to devices and components including apparatus, systems, and methods for user equipment group mobility caused by inter-donor full migration.

### TECHNICAL FIELD

This application relates generally to wireless communication, and in particular relates to technologies for user equipment group mobility caused by inter-donor full migration.

### BACKGROUND

Integrated access and backhaul (IAB) is a network technology in Third Generation Partnership Project (3GPP) to facilitate relaying of access traffic by sharing radio resources between access and backhaul links. In an IAB deployment, an IAB donor is a radio access network (RAN) node that provides an interface to a core network and provides wireless backhauling functionality to an IAB node. An IAB node is a RAN node that provides a UE with wireless access and wirelessly backhauls the access traffic to another IAB node or an IAB donor. In this manner, last mile connectivity may be improved when having a fiber backhaul to all access nodes is impractical.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates another signaling diagram in accordance with some embodiments.

FIG. 4 illustrates another signaling diagram in accordance with some embodiments.

FIG. 5 illustrates an operational flow/algorithmic structure in accordance with some embodiments.

FIG. 6 illustrates another operational flow/algorithmic structure in accordance with some embodiments.

FIG. 7 illustrates a user equipment in accordance with some embodiments.

FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

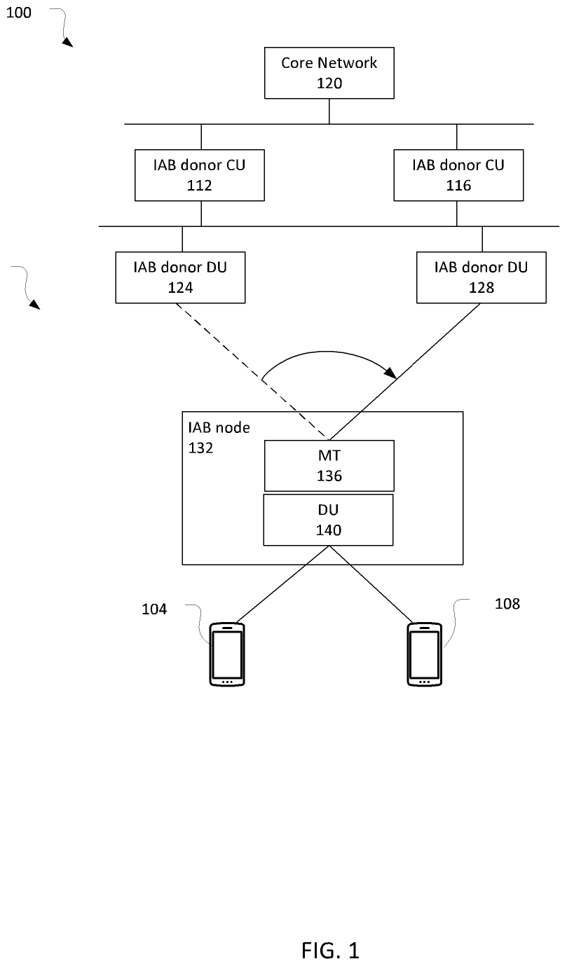

FIG. 1 illustrates a network environment 100 in accordance with some embodiments. The network environment 100 may include a number of IAB nodes that provide network access to UEs 104 and 108. In particular, the network environment 100 may include an IAB donor centralized unit (CU) 112 and IAB donor CU 116 coupled with a 3GPP core network 120 that offers various data and telecommunications services to customers/subscribers.

The IAB donor CUs 112 and 116 may be coupled with the core network 120 by a fiber backhaul connection. The fiber backhaul connection may facilitate communication of network traffic at higher speeds than those associated with, for example, 3GPP New Radio (NR) access links.

The network environment 100 may also include distributed units (DUs) coupled with the CUS. In particular, the network environment 100 may include an IAB donor DU 124 and IAB donor DU 128. In general, the CUs may handle higher-layer protocols, for example, radio resource control (RRC), packet data convergence (PDCP), and service data adaptation protocol (SDAP) layer protocols, while the DUs handle lower-layer protocols, for example, radio link control (RLC), media access control (MAC), and physical (PHY) layer protocols.

The network environment 100 may further include an IAB node 132 that includes a mobile termination (MT) 136 and a DU 140. The MT 136 may be used to connect the IAB node 132 with an upstream (for example, towards the core network 120) RAN node (for example, IAB donor DU 124 or IAB donor DU 128). In general, the MT 136 may provide the IAB node 132 with access functionality similar to a UE. For example, the MT 136 may utilize protocols that a typical UE may use to connect to a RAN. The MT 136 may, for example, allow the IAB node 132 to establish signaling radio bearers (SRBs) and/or data radio bearers (DRBs) with a parent node. The MT 136 may perform cell selection to identify an upstream RAN node to join and then set up and utilize an RLC channel through a backhaul adaptation (BAP) layer that provides functionality for routing data for different UE bearers over different routes through the network. The MT 136 may also perform, for example, cell reselection, radio-link failure, etc.

The DU 140 may be used to connect the IAB node 132 with the UEs 104 and 108. The DU 140 may establish RLC channels with the UEs 104 and 108.

Procedures may be defined for migration/topology adaptation to enable IAB-node mobility. This may include inter-donor migration of an entire mobile IAB node, such as IAB node 132, which may be referred to as full migration. Consideration may be provided for enhancements for mobility of an IAB node together with its served UEs, including aspects related to group mobility. Further, mitigation of interference due to IAB-node mobility may be considered. This may include the avoidance of potential reference and control signal collisions with respect to, for example, physical cell ID (PCI) and random access channel (RACH) procedures.

Improvements to mobility of the IAB node 132 may be done in a manner such that enhancements are backwards compatible, so that the IAB node 132 is still able to serve legacy UEs.

In some embodiments, mobile IAB nodes may support in-band and out-of-band backhauling; have no descendent IAB nodes (for example, serve only UEs), and support UE handover and dual connectivity. A mobile IAB node may operate in frequency range 1 (FR1), frequency range 2 (FR2), or another frequency range.

In Release 17 of 3GPP, inter-donor partial migration is provided in which an IAB MT can migrate to a different parent node underneath another IAB donor CU. In this case, the co-located IAB DU and the IAB DUs of its descendent nodes may retain F1 connectivity with the initial IAB donor CU. The IAB node may be referred to as a boundary IAB node. After inter-donor partial migration, the F1 traffic of the IAB DU and its descendent nodes is routed via the BAP layer of the topology to which the IAB MT has migrated. Inter-donor partial migration is only supported for standalone (SA) modes.

In inter-donor partial migration, the DU of the boundary node does not change after migration. It is still served by the initial IAB donor CU. Thus, the boundary node's DU, its descendent IAB nodes, and associated UEs do not need to perform migration or handover.

The IAB node 132 may perform an inter-donor full migration by transitioning both MT 136 and DU 140 from a connection with IAB donor DU 124 and IAB donor CU 112 to IAB donor DU 128 and IAB donor CU 116. When the DU 140 performs the inter-donor switch from IAB donor CU 112 to IAB donor CU 116, its connected UEs (e.g., UEs 104 and 108) may perform a group handover from IAB donor CU 112 to IAB donor CU 116. Embodiments of the present disclosure address issues that may arise with respect to a UE group mobility triggered by inter-donor full migration.

A first issue may occur when the source CU (for example, IAB donor CU 112) sends an RRC reconfiguration message to the UEs 104 and 108 to trigger group mobility. This message may be sent before the IAB MT 136 starts migration or after IAB DU 140 completes migration. Embodiments provide various procedure details to facilitate this operation.

A second issue may relate to management of a T304 timer. The T304 timer is used in handover scenarios. Typically, the T304 timer is started at a reception of an RRC reconfiguration message that includes a reconfiguration with synchronization parameter and stopped upon successfully completing a RACH procedure. However, given that the UEs 104 and 108 do not change DU connections with respect to an inter-donor full migration, the RACH procedure may be configured to be skipped. Thus, consideration of the T304 management may be desired.

In the event the IAB donor CU 112 sends the RRC reconfiguration message to the UEs 104 and 108 before the IAB MT 136 starts migration as discussed with respect to the first issue, a complication may exist in that the IAB node 132 is still connected to the source IAB donor CU 112. Thus, it is unclear how the IAB node 132 is to send a responsive RRC reconfiguration complete message to the target IAB donor CU as there is no direct path to the target before the migration.

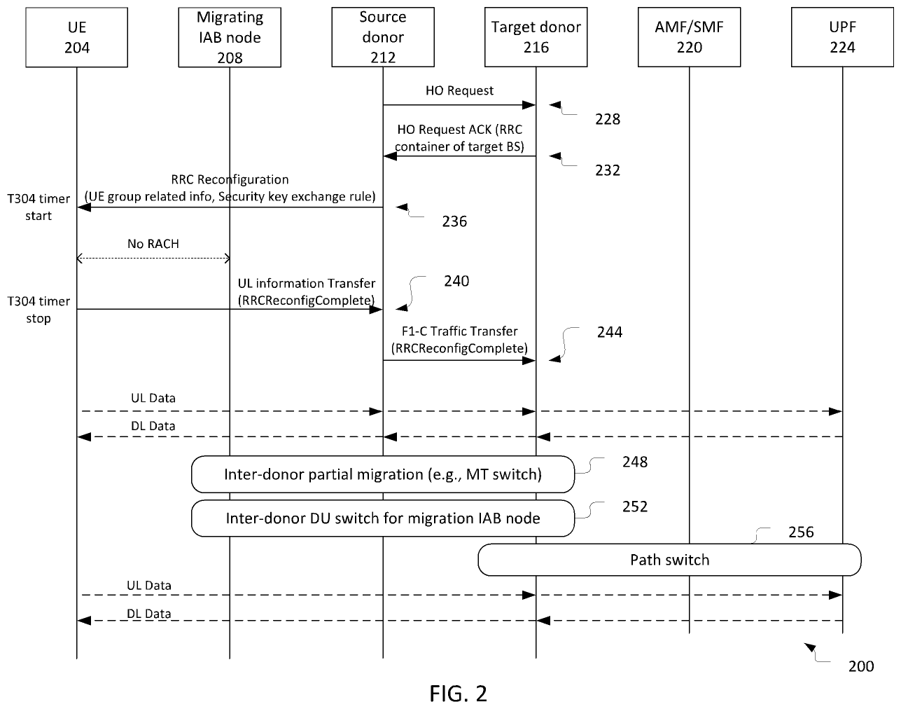

FIG. 2 is a signaling diagram 200 illustrating transmission of RRC reconfiguration and RRC reconfiguration complete messages before migration of an MT of a migrating IAB node 208 in accordance with some embodiments.

The signaling diagram 200 may include operations and signals between a UE 204, the migrating IAB node 208, a source donor 212, a target donor 216, an access and mobility function (AMF)/session management function (SMF) 220, and a user plane function (UPF) 224. The UE 204 may correspond to either or both UEs 104 or 108. The migrating IAB node 208 may correspond to IAB node 132. The source donor 212 may correspond to IAB donor CU 112. The target donor 216 may correspond to IAB donor CU 116. The AMF/SMF 220 and UPF 224 may reside in the core network 120.

At 228, the source donor 212 may send a handover (HO) request to the target donor 216. The handover request may include an RRC container with transport network layer (TNL) address information of the migrating IAB node 208.

The target donor 216 may perform an admission control and, at 232, may respond to the HO request by sending an HO request acknowledgment (ACK). The HO request acknowledgment may include an RRC container of a target base station. For example, the RRC container may include a new RRC configuration with a BAP address for a boundary node in a topology associated with the target donor 216, a default backhaul (BH) RLC channel, and a default BAP routing identifier configuration for uplink F1-C/non-F1 traffic mapping on a target path. The RRC configuration may further include new TNL address(es) anchored at the target donor 216 for the migrating IAB node 208.

At 236 , the source donor 212 may send an RRC reconfiguration message to the UE 204. The RRC reconfiguration message may be used to setup or modify an RRC connection. The RRC reconfiguration message may include group related information that pertains to a group of UEs that are to be involved with the group mobility procedures. The RRC reconfiguration message may further include a security key exchange rule to be used to modify the RRC connection.

The receipt of the RRC reconfiguration message may trigger the IAB MT migration for the UE 204. As the UE 204 may not change a DU connection, it may not need to perform a RACH procedure after receiving the RRC reconfiguration message.

At 240, the UE 204 may send an uplink (UL) information transfer message that includes an RRC reconfiguration complete message to the source donor 212. The RRC reconfiguration complete message may be used to confirm a successful completion of the RRC connection reconfiguration. The UL information transfer message, which may be transmitted via an SRB 2, may be a container that is used to convey the RRC reconfiguration complete message to the target donor 216 via the source donor 212.

The use of a T304 timer may differ in various embodiments. In some embodiments, the T304 timer may be set to infinity (for example, the UE 204 may not use the T304 timer). In other embodiments, the T304 timer may be set to a discrete value and started upon receiving the RRC reconfiguration message at 236. The UE 204 may stop the T304 timer based on the UL information transfer message at 240. In some embodiments, the T304 timer may be stopped when the UE 204 transmits the UL information transfer message at 240. In other embodiments, the T304 timer may be stopped upon reception of a positive lower-layer acknowledgment for transmission of the UL information transfer message that includes the RRC reconfiguration complete message. The lower layer acknowledgment may be an RLC acknowledgment or hybrid automatic repeat request (HARQ) acknowledgment.

In the event the T304 timer expires before a configured stop condition occurs, the UE 204 may perform an RRC re-establishment procedure with a cell selected through a cell selection process.

Upon receiving the UL information transfer message, the source donor 212 may, at 244, use an F1-C traffic transfer message to send the RRC reconfiguration complete message to the target donor 216. The F1-C traffic transfer message may be sent via an Xn interface between the source donor 212 and the target donor 216. The F1-C traffic transfer message may also include parameters to protect its content transferred over the F1-C interface. These parameters may include an F1-C interface stream control transmission protocol (SCTP) CHUNK and Internet protocol (IP) header or an IP packet. Unless otherwise described herein, the F1-C traffic transfer message may be similar to that described in 3GPP TS 38.472, v17.0.0 (2022-Apr.-05).

An uplink data path that may be used before a path switch 256 may be from the UE 204 to the source donor 212, from the source donor 212 to the target donor 216, and from the target donor 216 to the UPF 224. A downlink data path that may be used before the path switch 256 may be from the UPF 224 to the target donor 216, from the target donor 216 to the source donor 212, and from the source donor 212 to the UE 204.

The signaling diagram 200 may include an inter-donor partial migration at 248. The inter-donor partial migration may switch an MT of the migrating IAB node 208 from the source donor 212 to the target donor 216. The MT switch may be similar to that described in clause 8.17.3.1 of 3GPP TS 38.401, v17.1.1 (2022-Jul.-05).

After the inter-donor partial migration, the signaling diagram 200 may include an inter-donor DU switch for the migrating IAB node 208 at 252.

The path switch 256 may happen after the MT and DU switches. Following the path switch 256, the uplink data path may be from the UE 204 to the target donor 216, and from the target donor 216 to the UPF 224. The downlink data path that may be used after the path switch 256 may be from the UPF 224 to the target donor 216 and from the target donor 216 to the UE 204.

In the event the IAB donor CU 112 sends the RRC reconfiguration message to the UEs 104 and 108 after the IAB DU 140 completes migration as discussed with respect to the second issue, a complication may exist in that, after IAB-DU migration, the IAB node 132 may have already released the connection with the source IAB donor CU and connected to the target IAB donor CU 116. Thus, it is unclear how the source IAB donor CU 112 can send the RRC reconfiguration message to the UEs 104 and 108 as there is no direct path between these entities after the migration (and release of the source IAB donor CU 112).

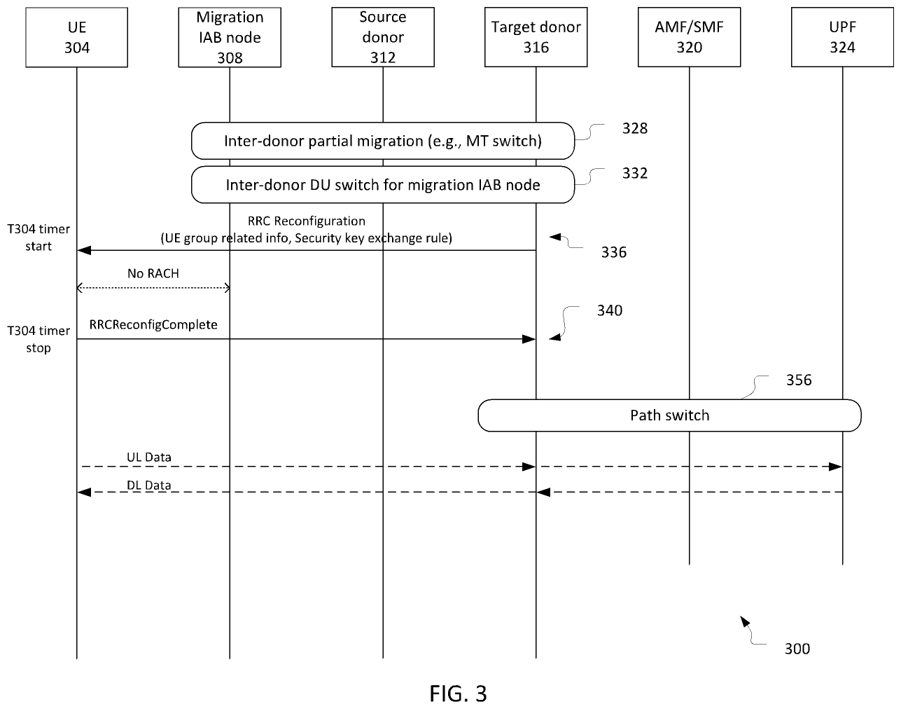

FIG. 3 is a signaling diagram 300 illustrating transmission of RRC reconfiguration and RRC reconfiguration complete messages after migration of a DU of a migrating IAB node 308 in accordance with some embodiments.

The signaling diagram 300 may include operations and signals between a UE 304, the migrating IAB node 308, a source donor 312, a target donor 316, an AMF/SMF 320, and a UPF 324. The UE 304 may correspond to either or both UEs 104 or 108. The migrating IAB node 308 may correspond to IAB node 132. The source donor 312 may correspond to IAB donor CU 112. The target donor 316 may correspond to IAB donor CU 116. The AMF/SMF 320 and UPF 324 may reside in the core network 120.

The signaling diagram 300 may include an inter-donor partial migration for an MT switch at 328 and an inter-donor DU switch for the migrating IAB node 308 at 332. These switches may be similar to the MT switch at 248 and DU switch at 252 discussed above with respect to FIG. 2.

The completion of the DU switch at 332 may trigger the target donor 316 to transmit an RRC reconfiguration message to the UE 304 at 336. As the target donor 316 has a connection with the UE 304 at this point, the RRC reconfiguration message may be transmitted via this connection. The RRC reconfiguration message may be similar to that discussed above with respect to FIG. 2.

In this embodiment, given that the target donor 316 initiates the IAB MT migration, there may be no need for the handover request or handover request acknowledgment as described above with respect to FIG. 2. Furthermore, in this embodiment, the source donor 312 does not need to send the RRC reconfiguration message.

The receipt of the RRC reconfiguration message may trigger the IAB MT migration for the UE 304. As the UE 304 may not change a DU connection, it may not need to perform a RACH procedure after receiving the RRC reconfiguration message.

At 340, the UE 304 may transmit an RRC reconfiguration complete message to the target donor 316 to confirm the RRC connection was successfully reconfigured. As both the MT and DU have migrated from the source donor 312 at this point, the RRC reconfiguration complete message may be transmitted directly to the target donor 316 without having to be sent through the source donor 312.

The use of a T304 timer may differ in various embodiments. In some embodiments, the T304 timer may be set to infinity (for example, the UE 304 may not use the T304 timer). In other embodiments, the T304 timer may be set to a discrete value and started upon receiving the RRC reconfiguration message at 336. The UE 304 may stop the T304 timer based on the RRC reconfiguration complete message at 340. In some embodiments, the T304 timer may be stopped when the UE 304 transmits the RRC reconfiguration complete message at 340. In other embodiments, the T304 timer may be stopped upon reception of a positive lower-layer acknowledgment for transmission of the RRC reconfiguration complete message. The lower layer acknowledgment may be an RLC acknowledgment or HARQ acknowledgment.

In the event the T304 timer expires before a configured stop condition occurs, the UE 304 may perform an RRC re-establishment procedure with a cell selected through a cell selection process.

Upon receiving the RRC reconfiguration complete message at 340, the target donor 316 and UPF 324 may perform a path switch 356. After the path switch at 356, the uplink data path may be from the UE 304 to the target donor 316, and from the target donor 316 to the UPF 324. The downlink data path that may be used after the path switch 356 may be from the UPF 324 to the target donor 316 and from the target donor 316 to the UE 304.

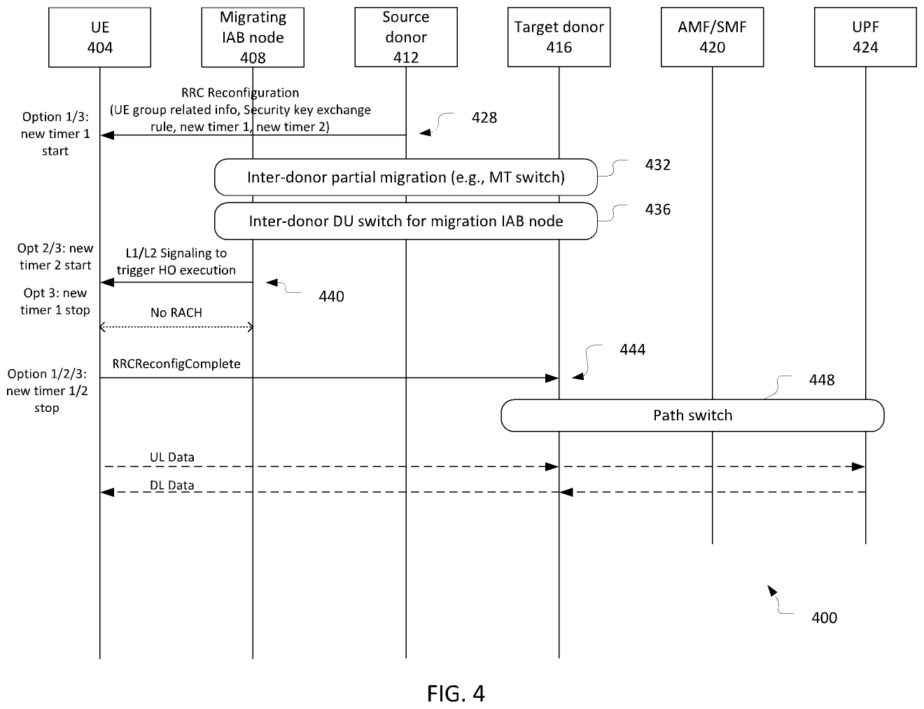

FIG. 4 is a signaling diagram 400 illustrating a delayed HO execution in accordance with some embodiments.

The signaling diagram 400 may include operations and signals between a UE 404, a migrating IAB node 408, a source donor 412, a target donor 416, an AMF/SMF 420, and a UPF 424. The UE 404 may correspond to either or both UEs 104 or 108. The migrating IAB node 408 may correspond to IAB node 132. The source donor 412 may correspond to IAB donor CU 112. The target donor 416 may correspond to IAB donor CU 116. The AMF/SMF 420 and UPF 424 may reside in the core network 120.

The signaling diagram 400 may include the source donor 412 transmitting an RRC reconfiguration message to the UE 404 at 428. The RRC reconfiguration message may be similar to that discussed above with respect to FIG. 2. However, in addition to the UE group related information and the security key exchange rule, the RRC reconfiguration message in this embodiment may further include values for one or more new timers (shown as new timer 1 and new timer 2).

The RRC reconfiguration message may provide information relevant to a handover. However, it may not, by itself, trigger the UE 404 to perform the handover. Rather the UE 404 may store the information and wait for the handover to be triggered at a later time.

After the source donor 412 transmits the RRC reconfiguration message at 428, the migrating IAB node 408 may perform an inter-donor partial migration for an MT switch at 432 and an inter-donor DU switch at 436. These switches may be similar to the MT switch at 248 and DU switch at 252 discussed above with respect to FIG. 2.

The signaling diagram 400 may further include, the migrating IAB node 408 transmitting layer 1 or layer 2 (L1/L2) signaling to the UE 404. The L1 signaling may include physical layer signaling (for example, downlink control information (DCI)), and the L2 signaling may include MAC layer signaling (for example, a MAC control element). The UE 404 may interpret the L1/L2 signaling as the trigger for the HO execution. Thereafter, the UE 404 may, at 444, transmit the RRC reconfiguration complete message to the target donor 416 to confirm the RRC connection was successfully reconfigured. As both the MT and DU have migrated from the source donor 412 at this point, the RRC reconfiguration complete message may be transmitted directly to the target donor 416 without having to be sent through the source donor 412.

In this embodiment, the UE 404 may manage the new timers in accordance with one or more of the following options.

In a first option, upon receiving the RRC reconfiguration message at 428, the UE 404 may only start the new timer 1. As discussed above, the UE 404 may store the other information in the RRC reconfiguration message without applying it in a handover situation at this point. The new timer 1 may be stopped when the UE 404 transmits the RRC reconfiguration complete message at 444 or upon reception of a positive lower-layer acknowledgment for transmission of the RRC reconfiguration complete message. The lower layer acknowledgment may be an RLC acknowledgment or HARQ acknowledgment. In the event the new timer 1 expires before a configured stop condition occurs, the UE 404 may perform an RRC re-establishment procedure with a cell selected through a cell selection process. Using the new timer 1 in this manner may account for the use of the L1/L2 signaling to trigger HO execution, given that there is not feedback to the network based on the L1/L2 signaling.

In a second option, the UE 404 may not start any timer upon reception of the RRC reconfiguration message at 428. Rather, the UE 404 may start new timer 2 upon reception of the L1/L2 signaling at 440. It doesn't apply other information (e. g, it may only store them). The new timer 2 may be stopped when the UE 404 transmits the RRC reconfiguration complete message at 444 or upon reception of a positive lower-layer acknowledgment for transmission of the RRC reconfiguration complete message. The lower layer acknowledgment may be an RLC acknowledgment or HARQ acknowledgment. In the event the new timer 2 expires before a configured stop condition occurs, the UE 404 may perform an RRC re-establishment procedure with a cell selected through a cell selection process In a third option, the UE 404 may start new timer 1 upon reception of the RRC reconfiguration message at 428. Upon receiving the L1/L2 signaling at 440, the UE 404 may stop the new timer 1 and start new timer 2. It doesn't apply other information (e.g., it may only store them). The new timer 2 may be stopped when the UE 404 transmits the RRC reconfiguration complete message at 444 or upon reception of a positive lower-layer acknowledgment for transmission of the RRC reconfiguration complete message. The lower layer acknowledgment may be an RLC acknowledgment or HARQ acknowledgment.

In some embodiments, if the new timer 1 expires in the third option before receiving the L1/L2 signaling, the UE 404 may perform an RRC re-establishment procedure with a cell selected through a cell selection process. In other embodiments, if the new timer 1 expires in the third option before receiving the L1/L2 signaling, the UE 404 may request a base station to send L1/L2 signaling to trigger the handover. The request may be transmitted by uplink L1/L2 signaling. After transmitting the request, the UE 404 may monitor for a response from the base station within a configurable window. If no response is received and the window expires, the UE 404 may perform an RRC re-establishment procedure.

Upon receiving the RRC reconfiguration complete message at 444, the target donor 416 and UPF 424 may perform a path switch 448. After the path switch at 448, the uplink data path may be from the UE 404 to the target donor 416, and from the target donor 416 to the UPF 424. The downlink data path that may be used after the path switch 448 may be from the UPF 424 to the target donor 416 and from the target donor 416 to the UE 404.

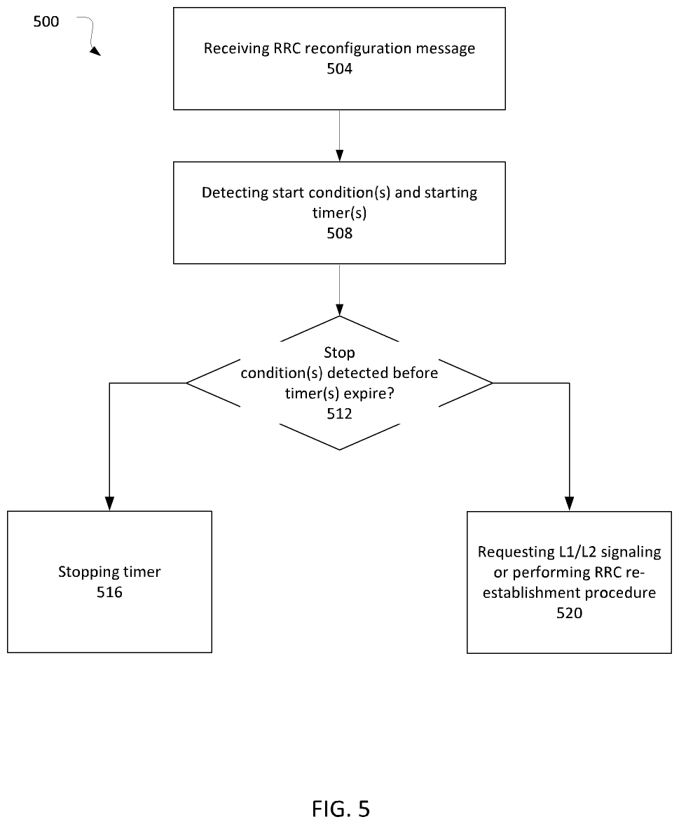

FIG. 5 provides an operation flow/algorithmic structure 500 in accordance with some embodiments. The operation flow/algorithmic structure 500 may be performed by a user equipment such as UE 104, 204, 304, 404, or 700; or components thereof, for example, processors 704.

The operation flow/algorithmic structure 500 may include, at 504, receiving an RRC reconfiguration message. The RRC reconfiguration message may initiate a handover. The handover may include, for example, an IAB-MT migration. In some embodiments, the RRC reconfiguration message may include one or more timer values that may be used with respect to the handover.

The operation flow/algorithmic structure 500 may further include, at 508, detecting start condition(s) and starting a timer(s). The operation flow/algorithmic structure 500 may further include, at 512, determining whether configured stop condition(s) detected before corresponding timer(s) expire.

The timers included and the corresponding start/stop conditions may be different in different embodiments.

In some embodiments, the timers may include a T304 timer with a start condition associated with receipt of the RRC reconfiguration message and a stop condition associated with transmission of an RRC reconfiguration complete message by the UE, or receipt of lower-level acknowledgment associated with the RRC reconfiguration complete message.

In some embodiments, the timers may include a new timer 1 with a start condition associated with receipt of the RRC reconfiguration message and a stop condition associated with transmission of an RRC reconfiguration complete message by the UE, or receipt of lower-level acknowledgment associated with the RRC reconfiguration complete message. These embodiments may be appropriate for delayed handover execution that is triggered by L1/L2 signaling.

In some embodiments, the timers may include a new timer 2 with a start condition associated with receipt of the L1/L2 signaling that triggers HO execution and a stop condition associated with transmission of an RRC reconfiguration complete message by the UE, or receipt of lower-level acknowledgment associated with the RRC reconfiguration complete message.

In some embodiments, the timers may include both a new timer 1 and a new timer 2. The new timer 1 may have a start condition associated with the receipt of the RRC reconfiguration message and a stop condition associated with the receipt of L1/L2 signaling that triggers HO execution. The new timer 2 may have a start condition associated with the receipt of the L1/L2 signaling that triggers HO execution and a stop condition associated with transmission of an RRC reconfiguration complete message by the UE, or receipt of lower-level acknowledgment associated with the RRC reconfiguration complete message.

If a stop condition is detected before corresponding timer expires at 512, the operation flow/algorithmic structure 500 may advance to stopping the timer at 516.

If a stop condition is not detected before corresponding timer expires at 512, the operation flow/algorithmic structure 500 may advance to requesting L1/L2 signaling or performing RRC reestablishment procedure at 520.

The request for L1/L2 signaling may occur when a new timer 1 has a start condition of receiving the RRC configuration message and a stop condition of receiving the L1/L2 signaling. If the UE does not receive the L1/L2 signaling and the new timer 1 expires, the UE may request that a base station send the L1/L2 signaling. If the L1/L2 signaling is not received within a window that follows the request, the UE may then proceed to perform the RRC reestablishment procedure. The start and length of the window may be predefined or configured by the network.

The performing of the RRC re-establishment procedure may be upon expiration of a timer that has a stop condition that is the transmission of the RRC reconfiguration complete message by the UE, or receipt of lower-level acknowledgment associated with the RRC reconfiguration complete message. In some embodiments, the RRC re-establishment procedure may be performed if the new timer 1, which has a stop condition of receiving the L1/L2 signaling, expires. This may be done immediately after expiration of the new timer 1 or after a window expires after transmitting the request for the L1/L2 signaling as discussed above.

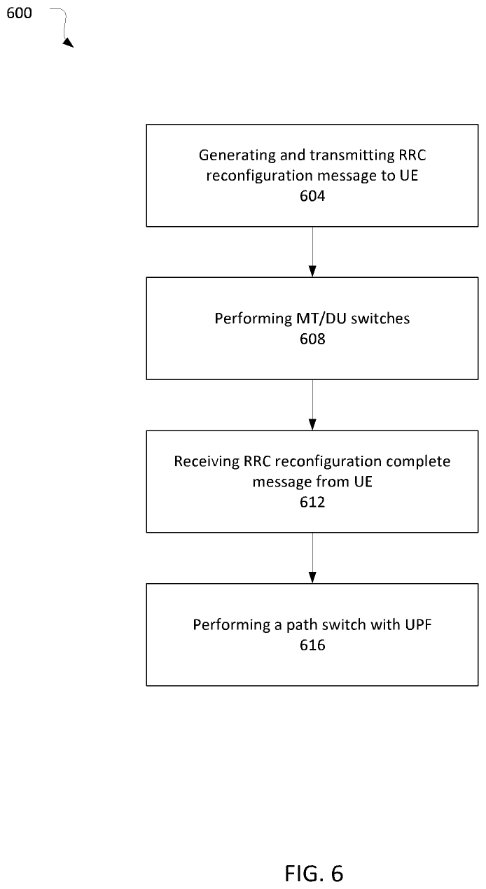

FIG. 6 provides an operation flow/algorithmic structure 600 in accordance with some embodiments. The operation flow/algorithmic structure 600 may be performed by a target donor CU such as IAB donor CU 116, target donor 216, target donor 316, target donor 416, or network node 800; or components thereof, for example, processors 804.

The operation flow/algorithmic structure 600 may include, at 604, generating and transmitting an RRC reconfiguration message to a UE. The RRC reconfiguration message may initiate a handover (for example, an IAB-MT migration) as discussed elsewhere herein.

The operation flow/algorithmic structure 600 may further include, at 608, performing MT and DU switches. The MT switch may be performed as part of an inter-donor partial migration to switch an MT connection from a source donor to the target donor. The DU switch may be an inter-donor switch for a migrating IAB node to switch the DU connection from the source donor to the target donor.

In some embodiments, the RRC reconfiguration message may be transmitted before the MT/DU switches. In other embodiments, the RRC reconfiguration message may be transmitted after the MT/DU switches.

The operation flow/algorithmic structure 600 may further include, at 612, receiving an RRC reconfiguration complete message from the UE. The RRC reconfiguration complete message may provide an indication of the successful reconfiguration of the RRC connection.

The operation flow/algorithmic structure 600 may further include, at 616, performing a path switch with a UPF. Following the path switch, uplink data may be sent from the UE to the target donor and from the target donor to the UPF; and downlink data may be sent from the UPF to the target donor and from the target donor to the UE.

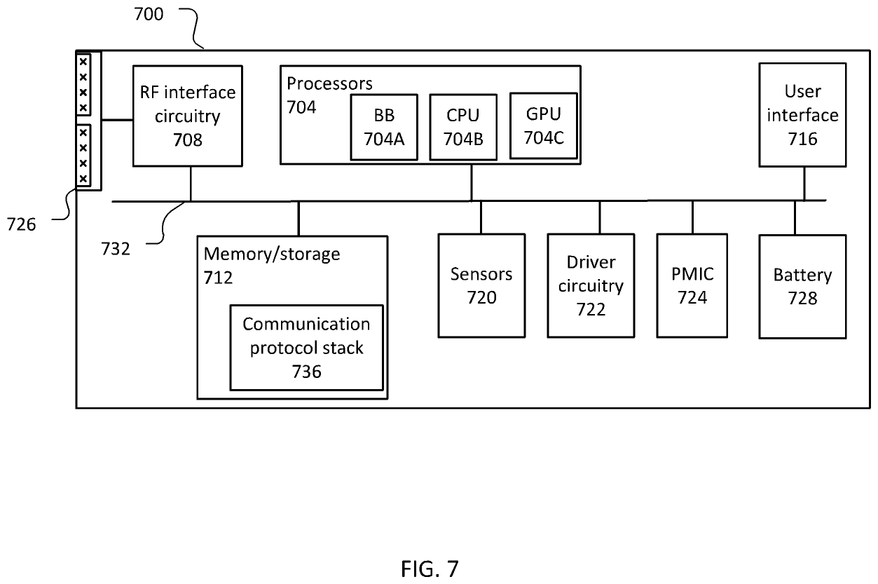

FIG. 7 illustrates an example UE 700 in accordance with some embodiments. The UE 700 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, optical connection, etc. that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple-input, multiple-output communications. The antenna 726 may include microstrip antennas, printed antennas fabricated on the surface of one or more printed circuit boards, patch antennas, phased array antennas, etc. The antenna 726 may have one or more panels designed for specific frequency bands including bands in FR1 or FR2.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within, or connected to, the UE 700. For example, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 700 may power down for brief intervals of time and thus save power. If there is no data traffic activity for an extended period of time, then the UE 700 may transition off to an RRC_Idle state, where it disconnects from the network and does not perform operations such as channel quality feedback, handover, etc. The UE 700 goes into a very low power state and it performs paging where again it periodically wakes up to listen to the network and then powers down again. The UE 700 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 728 may power the UE 700, although in some examples the UE 700 may be mounted or deployed in a fixed location, and may have a power supply coupled to an electrical grid. The battery 728 may be a lithium-ion battery or a metal-air battery such as a zinc-air battery, an aluminum-air battery, a lithium-air battery, and the like. In some implementations, such as in vehicle-based applications, the battery 728 may be a typical lead-acid automotive battery.

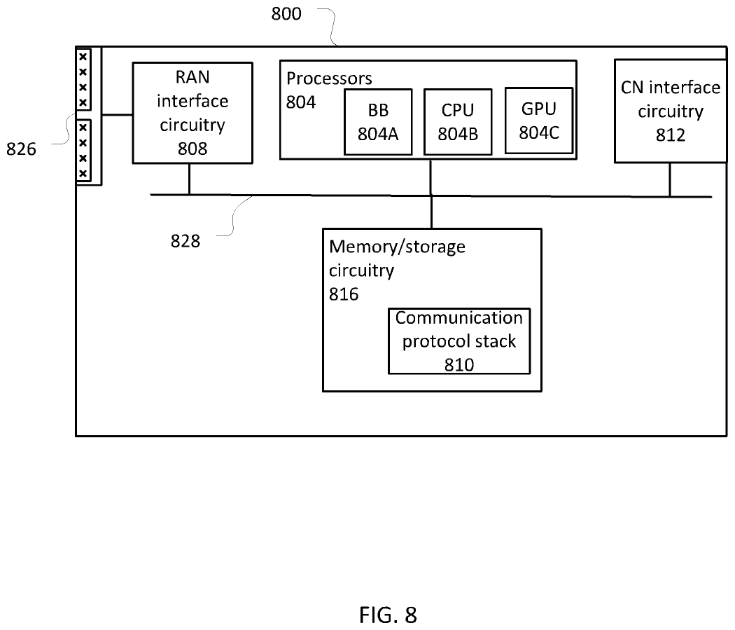

FIG. 8 illustrates an example network node 800 in accordance with some embodiments. The network node 800 may be a base station, migrating IAB node, source donor, or target donor as described elsewhere herein. The network node 800 may include processors 804, RF interface circuitry 808, core network (CN) interface circuitry 812, memory/storage circuitry 816, and antenna structure 826.

The components of the network node 800 may be coupled with various other components over one or more interconnects 828.

The processors 804, RF interface circuitry 808, memory/storage circuitry 816 (including communication protocol stack 810), antenna structure 826, and interconnects 828 may be similar to like-named elements shown and described with respect to FIG. 7.

The CN interface circuitry 812 may provide connectivity to a core network, for example, a 5th Generation Core network (5GC) using a 5GC-compatible network interface protocol such as carrier Ethernet protocols, or some other suitable protocol. Network connectivity may be provided to/from the network node 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a user equipment (UE), the method comprising: receiving, from a source donor centralized unit (CU), a radio resource control (RRC) reconfiguration message to initiate a handover (for example, an integrated access and backhaul (IAB)-mobile terminal (MT) migration); and generating an uplink information transfer container having an RRC reconfiguration complete message to be transmitted to a target donor CU via the source donor CU.

Example 2 includes the method of example 1 or some other example herein, further comprising: transmitting the RRC reconfiguration complete message using signaling radio bearer 2 (SRB2).

Example 3 includes the method of example 1 or some other example herein, further comprising: starting a T304 timer based on receiving the RRC reconfiguration message.

Example 4 includes a method of example 3 or some other example herein, further comprising: transmitting the RRC reconfiguration complete message; and stopping the T304 timer based on transmitting the RRC reconfiguration complete message.

Example 5 includes a method of example 3 or some other example herein, further comprising: transmitting the RRC reconfiguration complete message; receiving an acknowledgment associated with the RRC reconfiguration complete message; and stopping the T304 timer based on receiving the acknowledgment.

Example 6 includes a method of example 5 or some other example herein, wherein the acknowledgment is a radio link control (RLC) acknowledgment or a hybrid automatic repeat request (HARQ) acknowledgment.

Example 7 includes a method of any one of examples 3-6 or some other example herein, further comprising: detecting an expiration of the T304 timer; and performing an RRC reestablishment based on the expiration of the T304 timer.

Example 8 includes the method of example 1 or some other example herein, further comprising: receiving, from the target donor CU, an instruction to switch from a path through the source donor CU to a path through the target donor CU.

Example 9 includes a method of operating a source donor centralized unit (CU), the method comprising: transmitting, to a user equipment (UE), a radio resource control (RRC) reconfiguration message to initiate a handover (for example, an integrated access and backhaul (IAB)-mobile terminal (MT) migration); receiving, from the UE in an uplink information transfer container, an RRC reconfiguration complete message; and transmitting the RRC reconfiguration complete message to a target donor CU.

Example 10 includes the method of example 9 or some other example herein, wherein transmitting the RRC reconfiguration complete message further comprises: transmitting the RRC reconfiguration complete message in an F1-control (F1-C) traffic transfer message.

Example 11 includes the method of example 10 or some other example herein, wherein the F1-C traffic transfer message comprises: an F1-C interface stream control transmission protocol (SCTP) CHUNK and Internet protocol (IP) header; or an IP packet.

Example 12 includes a method of operating a target donor centralized unit (CU), the method comprising: transmitting, to a user equipment (UE), a radio resource control (RRC) reconfiguration message to initiate an integrated access and backhaul (IAB)-mobile terminal (MT) migration based on a determination that an inter-donor distributed unit (DU) switch has been completed; and receiving, from the UE, an RRC reconfiguration complete message.

Example 13 includes a method of example 12 or some other example herein, further comprising: transmitting, to the UE based on receiving the RRC reconfiguration complete message, an instruction to switch from a path through a source donor CU to a path through the target donor CU.

Example 14 includes a method of operating a user equipment (UE), the method comprising: receiving, from a target donor centralized unit (CU) after an inter-donor distributed unit (DU) switch has been completed, a radio resource control (RRC) reconfiguration message to initiate a handover (for example, an integrated access and backhaul (IAB)-mobile terminal (MT) migration); and transmitting, to the target donor CU, an RRC reconfiguration complete message.

Example 15 includes the method of example 14 or some other example herein, further comprising: starting a T304 timer based on receiving the RRC reconfiguration message.

Example 16 includes the method of example 15 or some other example herein, further comprising: stopping the T304 timer based on transmitting the RRC reconfiguration complete message.

Example 17 includes the method of example 15 or some other example herein, further comprising: receiving an acknowledgment associated with the RRC reconfiguration complete message; and stopping the T304 timer based on receiving the acknowledgment.

Example 18 includes the method of example 17 or some other example herein, wherein the acknowledgment is a radio link control (RLC) acknowledgment or a hybrid automatic repeat request (HARQ) acknowledgment.

Example 19 includes the method of example 14 or some other example herein, further comprising: receiving, from the target donor CU, an instruction to switch from a path through a source donor CU to a path through the target donor CU.

Example 20 includes a method of operating a user equipment (UE), the method comprising: receiving, from a target donor centralized unit (CU), a radio resource control (RRC) reconfiguration message having a timer value; receiving, from a migration integrated access and backhaul (IAB) node, a layer 1 or layer 2 (L1/L2) signal to trigger an IAB-mobile terminal (MT) migration; starting a timer with the timer value based on said receiving of the RRC reconfiguration message or the L1/L2 signal; and determining whether to transmit an RRC reconfiguration complete message to the target donor CU or perform an RRC reestablishment procedure based on the timer.

Example 21 includes the method of example 20 or some other example herein, further comprising: transmitting the RRC reconfiguration complete message; and stopping the timer based on transmitting the RRC reconfiguration complete message or reception of an acknowledgment associated with the RRC reconfiguration complete message.

Example 22 includes a method of example 20 or some other example herein, wherein the timer value is a first timer value, the timer is a first timer, and the RRC reconfiguration message further has a second timer value.

Example 23 includes the method of example 22 or some other example herein, further comprising: stopping the first timer based on said receiving of the L1/L2 signal; and starting a second timer with the second timer value based on said receiving of the L1/L2 signal.

Example 24 includes a method of example 23 or some other example herein, further comprising: transmitting the RRC reconfiguration complete message; and stopping the second timer based on transmitting the RRC reconfiguration complete message or reception of an acknowledgment associated with the RRC reconfiguration complete message.

Example 25 includes a method of operating a user equipment (UE), the method comprising: receiving, from a target donor centralized unit (CU), a radio resource control (RRC) reconfiguration message having a first timer value and a second timer value; starting a first timer with the first timer value based on said receiving of the RRC reconfiguration message; and determining whether a layer 1 or layer 2 (L1/L2) signal to trigger execution of a handover is received before received before expiration of the first timer.

Example 26 includes the method of example 25 or some other example herein, further comprising: determining the first timer expires before reception of the L1/L2 signal; and performing an RRC re-establishment procedure based on said determining the first timer expires before reception of the L1/L2 signal.

Example 27 includes the method of example 25 or some other example herein, further comprising: determining the first timer expires before reception of the L1/L2 signal; and transmitting, to a base station, a request for the L1/L2 signal; determining whether the L1/L2 signal is received within a window of time after transmitting the request; and performing a handover or an RRC re-establishment procedure based on said determining whether the L1/L2 signal is received within the window of time.

Example 28 includes the method of example 22 or some other example herein, further comprising: receiving the L1/L2 signal before the first timer expires; stopping the first timer based on said receiving the L1/L2 signal; and starting a second timer with the second timer value based on said receiving the L1/L2 signal. Example 29 may include an apparatus comprising means to perform one or more elements of a method described in or related to any of examples 1-28, or any other method or process described herein.

Example 30 may include one or more non-transitory computer-readable media comprising instructions to cause an electronic device, upon execution of the instructions by one or more processors of the electronic device, to perform one or more elements of a method described in or related to any of examples 1-28, or any other method or process described herein.

Example 31 may include an apparatus comprising logic, modules, or circuitry to perform one or more elements of a method described in or related to any of examples 1-28, or any other method or process described herein.

Example 32 may include a method, technique, or process as described in or related to any of examples 1-28, or portions or parts thereof.

Example 33 may include an apparatus comprising: one or more processors and one or more computer-readable media comprising instructions that, when executed by the one or more processors, cause the one or more processors to perform the method, techniques, or process as described in or related to any of examples 1-28, or portions thereof.

Example 34 may include a signal as described in or related to any of examples 1-28, or portions or parts thereof.

Example 35 may include a datagram, information element, packet, frame, segment, PDU, or message as described in or related to any of examples 1-28, or portions or parts thereof, or otherwise described in the present disclosure.

Example 36 may include a signal encoded with data as described in or related to any of examples 1-28, or portions or parts thereof, or otherwise described in the present disclosure.

Example 37 may include a signal encoded with a datagram, IE, packet, frame, segment, PDU, or message as described in or related to any of examples 1-28, or portions or parts thereof, or otherwise described in the present disclosure.

Example 38 may include an electromagnetic signal carrying computer-readable instructions, wherein execution of the computer-readable instructions by one or more processors is to cause the one or more processors to perform the method, techniques, or process as described in or related to any of examples 1-28, or portions thereof.

Example 39 may include a computer program comprising instructions, wherein execution of the program by a processing element is to cause the processing element to carry out the method, techniques, or process as described in or related to any of examples 1-28, or portions thereof.

Example 40 may include a signal in a wireless network as shown and described herein.

Example 41 may include a method of communicating in a wireless network as shown and described herein.

Example 42 may include a system for providing wireless communication as shown and described herein.

Example 43 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-31. (Canceled).

32. A method comprising:
receiving, from a source donor centralized unit (CU), a radio resource control (RRC) reconfiguration message to initiate a handover; and
generating an uplink information transfer container having an RRC reconfiguration complete message to be transmitted to a target donor CU via the source donor CU.

33. The method of claim 32, wherein the handover comprises an integrated access and backhaul (IAB) mobile terminal (MT) migration.

34. The method of claim 32, further comprising:
causing the RRC reconfiguration complete message to be transmitted using signaling radio bearer 2 (SRB2).

35. The method of claim 32, further comprising:
starting a T304 timer based on receiving the RRC reconfiguration message.

36. The method of claim 35, further comprising:
causing the RRC reconfiguration complete message to be transmitted; and
stopping the T304 timer based on transmission of the RRC reconfiguration complete message.

37. The method of claim 35, further comprising:
causing the RRC reconfiguration complete message to be transmitted;
receiving an acknowledgment associated with the RRC reconfiguration complete message; and
stopping the T304 timer based on receiving the acknowledgment.

38. The method of claim 37, wherein the acknowledgment is a radio link control (RLC) acknowledgment or a hybrid automatic repeat request (HARQ) acknowledgment.

39. The method of claim 35, further comprising:
detecting an expiration of the T304 timer; and
performing an RRC reestablishment operation based on the expiration of the T304 timer.

40. The method of claim 32, further comprising:
receiving, from the target donor CU, an instruction to switch from a path through the source donor CU to a path through the target donor CU.

41. One or more non-transitory, computer-readable media having instructions that, when executed, cause processor circuitry to:
generate a radio resource control (RRC) reconfiguration message for transmission to a user equipment (UE) to initiate an integrated access and backhaul (IAB)-mobile terminal (MT) migration;
receiving, from the UE in an uplink information transfer container, an RRC reconfiguration complete message; and
causing transmission of the RRC reconfiguration complete message to a target donor centralized unit (CU).

42. The one or more non-transitory, computer-readable media of claim 41, wherein the instructions, when executed, further cause the processor circuitry to:
generate an F1-control (F1-C) traffic transfer message to include the RRC reconfiguration complete message.

43. The one or more non-transitory, computer-readable media of claim 42, wherein the F1-C traffic transfer message comprises an F1-C interface stream control transmission protocol (SCTP) CHUNK and Internet protocol (IP) header.

44. The one or more non-transitory, computer-readable media of claim 42, wherein the F1-C traffic transfer message comprises an Internet protocol (IP) packet.

45. An apparatus comprising:
processor circuitry to:
receive, from a target donor centralized unit (CU), a radio resource control (RRC) reconfiguration message having a timer value;
receive, from a migration integrated access and backhaul (IAB) node, a layer 1 or layer 2 (L1/L2) signal to trigger a handover;
start a timer with the timer value based on receipt of the RRC reconfiguration message or the L1/L2 signal; and
determine whether to transmit an RRC reconfiguration complete message to the target donor CU or perform an RRC reestablishment procedure based on the timer; and
interface circuitry coupled with the processor circuitry to enable communication.

46. The apparatus of claim 45, wherein the handover is an IAB-mobile terminal (MT) migration.

47. The apparatus of claim 45, wherein the processor circuitry is further to:
stop the timer based on transmission of the RRC reconfiguration complete message or reception of an acknowledgment associated with the RRC reconfiguration complete message.

48. The apparatus of claim 45, wherein the timer value is a first timer value, the timer is a first timer, and the RRC reconfiguration message further has a second timer value.

49. The apparatus of claim 48, wherein the processor circuitry is further to:
stop the first timer based on receipt of the L1/L2 signal.

50. The apparatus of claim 49, wherein the processor circuitry is further to:
start a second timer with the second timer value based on receipt of the L1/L2 signal.

51. The apparatus of claim 50, wherein the processor circuitry is further to:
stop the second timer based on transmission the RRC reconfiguration complete message or reception of an acknowledgment associated with the RRC reconfiguration complete message.
